(19) United States
(12) Patent Application Publication
(10) Pub. No.: US 2024/0127846 A1
(43) Pub. Date: Apr. 18, 2024

(54) ARTICULATION ABNORMALITY DETECTION METHOD, ARTICULATION ABNORMALITY DETECTION DEVICE, AND RECORDING MEDIUM

(71) Applicant: Panasonic Holdings Corporation, Osaka (JP)

(72) Inventors: Katsunori Daimo, Osaka (JP); Shogo TAKAHATA, Shiga (JP); Kazunori KAWAMI, Shiga (JP); Seiki NAGAO, Shiga (JP); Ryota OHMAE, Shiga (JP)

(21) Appl. No.: 18/535,106

(22) Filed: Dec. 11, 2023

Related U.S. Application Data
(63) Continuation of application No. PCT/JP2022/023365, filed on Jun. 9, 2022.

(30) Foreign Application Priority Data
Jun. 22, 2021 (JP) 2021-103673

(51) Int. Cl. G10L 25/54; G10L 15/06; G10L 25/90

(52) U.S. Cl. CPC G10L 25/54; G10L 15/063; G10L 25/90

(57) ABSTRACT

An articulation abnormality detection method includes: calculating an acoustic feature from utterance data of a speaker; calculating, from the acoustic feature, a first speaker feature indicating a speaker characteristic of the utterance data by using a trained deep neural network (DNN); calculating a degree of similarity between a second speaker feature of the speaker and the first speaker feature, where the second speaker feature is a speaker feature obtained when the speaker articulated properly; and determining whether the speaker has an articulation abnormality, based on the degree of similarity.

### CROSS REFERENCE TO RELATED APPLICATIONS

This is a continuation application of PCT International Application No. PCT/JP2022/023365 filed on Jun. 9, 2022, designating the United States of America, which is based on and claims priority of Japanese Patent Application No. 2021-103673 filed on Jun. 22, 2021. The entire disclosures of the above-identified applications, including the specifications, drawings and claims are incorporated herein by reference in their entirety.

### FIELD

The present disclosure relates to an articulation abnormality detection method, an articulation abnormality detection device, and a recording medium.

### BACKGROUND

As a technique for detection of an articulation abnormality (also called an articulation disorder) that is a condition of not being able to properly pronounce words, Non-Patent Literature (NPL) 1 discloses a method for analyzing a voice using deep learning, for example.

### CITATION LIST

### Non Patent Literature

NPL 1: Vuppalapati, C., Kedari, S., Ramalingamm, A. (2018). IEEE FEMH Voice Data Challenge 2018. IEEE International Conference on Big Data.

### SUMMARY

### Technical Problem

A technique using the above-described machine learning method is dependent on the amount and quality of training data (also called teaching data) for detection accuracy. However, it is difficult to secure a large amount of training data that is to be obtained from speakers when the speakers articulate abnormally. For this reason, symptoms showing articulation abnormalities that are not included in training data cannot be detected, for example.

The present disclosure aims to provide an articulation abnormality detection method, an articulation abnormality detection device, and a recording medium that are capable of improving detection accuracy without being dependent on the amount of training data that is to be obtained from speakers when the speakers articulate abnormally.

### Solution to Problem

An articulation abnormality detection method according to one aspect of the present disclosure includes: calculating an acoustic feature from utterance data of a speaker; calculating, from the acoustic feature, a first speaker feature indicating a speaker characteristic of the utterance data by using a trained deep neural network (DNN); calculating a degree of similarity between a second speaker feature of the speaker and the first speaker feature, the second speaker feature being a speaker feature obtained when the speaker articulated properly; and determining whether the speaker has an articulation abnormality, based on the degree of similarity.

### Advantageous Effects

The present disclosure can provide an articulation abnormality detection method, an articulation abnormality detection device, and a recording medium that are capable of improving detection accuracy without being dependent on the amount of training data that is to be obtained from speakers when the speakers articulate abnormally.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating an articulation abnormality detection device according to Embodiment 1.

FIG. 2 is a block diagram illustrating a speaker feature calculator according to Embodiment 1.

FIG. 3 is a flowchart illustrating an articulation abnormality detection process according to Embodiment 1.

FIG. 4 is a block diagram illustrating an articulation abnormality detection device according to Embodiment 2.

FIG. 5 is a flowchart illustrating an articulation abnormality detection process according to Embodiment 2.

FIG. 6 is a block diagram illustrating an articulation abnormality detection device according to Embodiment 3.

FIG. 7 is a flowchart illustrating an articulation abnormality detection process according to Embodiment 3.

### DESCRIPTION OF EMBODIMENTS

An articulation abnormality detection method according to one aspect of the present disclosure includes: calculating an acoustic feature from utterance data of a speaker; calculating, from the acoustic feature, a first speaker feature indicating a speaker characteristic of the utterance data by using a trained deep neural network (DNN); calculating a degree of similarity between a second speaker feature of the speaker and the first speaker feature, where the second speaker feature is a speaker feature obtained when the speaker articulated properly; and determining whether the speaker has an articulation abnormality, based on the degree of similarity. According to the above, since the articulation abnormality detection method does not require training data that is to be obtained from a speaker when the speaker articulates abnormally, the articulation abnormality detection method can implement a detection process not being dependent on the amount of training data that is to be obtained from a speaker when the speaker articulates abnormally. Furthermore, the articulation abnormality detection method can accurately detect an articulation abnormality with a simple configuration by calculating a first speaker feature using a trained deep neural network (DNN) for distinguishing a speaker characteristic and determining an articulation abnormality based on a degree of similarity between the first speaker feature and a second speaker feature that is obtained when the speaker articulated properly.

For example, in the determining, the speaker may be determined to have an articulation abnormality when the degree of similarity is less than a predetermined first threshold.

For example, in the calculating of the acoustic feature, acoustic features including the acoustic feature may be calculated from respective items of utterance data of the speaker including the utterance data. In the calculating of the first speaker feature, first speaker features including the first speaker feature may be calculated from the acoustic features by using the trained DNN. In the calculating of the degree of similarity, degrees of similarity between the second speaker feature and the first speaker features may be calculated, where the degrees of similarity include the degree of similarity. In the determining: a variance of the degrees of similarity may be calculated, and when the variance is greater than a predetermined second threshold, the speaker may be determined to have an articulation abnormality.

According to the above, the articulation abnormality detection method can accurately detect an articulation abnormality by taking advantage of a predisposition to difficulty in repeating the same phrase when a speaker is articulating abnormally.

For example, the articulation abnormality detection method may further include calculating an acoustic statistic from the utterance data. The determining may include determining whether the speaker has an articulation abnormality, based on the degree of similarity and the acoustic statistic.

According to the above, the articulation abnormality detection method can accurately detect an articulation abnormality by making a determination with consideration given to an acoustic statistic, in addition to the degree of similarity between the first speaker feature and second speaker feature that is obtained when the speaker articulated properly.

For example, the acoustic statistic may include a pitch variation, and in the determining, a possibility of the speaker having an articulation abnormality may be determined to be higher for smaller pitch variations.

For example, the acoustic statistic may include waveform periodicity, and in the determining, a possibility of the speaker having an articulation abnormality may be determined to be higher for shorter waveform periodicity.

For example, the acoustic statistic may include skewness, and in the determining, a possibility of the speaker having an articulation abnormality may be determined to be higher for greater skewness.

An articulation abnormality detection device according to one aspect of the present disclosure includes: an acoustic feature calculator that calculates an acoustic feature from utterance data of a speaker; a speaker feature calculator that calculates, from the acoustic feature, a first speaker feature indicating a speaker characteristic of the utterance data by using a trained deep neural network (DNN); a similarity degree calculator that calculates a degree of similarity between a second speaker feature of the speaker and the first speaker feature, where the second speaker feature is a speaker feature obtained when the speaker articulated properly; and an articulation abnormality determiner that determines whether the speaker has an articulation abnormality, based on the degree of similarity.

According to the above, since the articulation abnormality detection device does not require training data that is to be obtained from a speaker when the speaker articulates abnormally, the articulation abnormality detection device can implement a detection process not being dependent on the amount of training data that is to be obtained from a speaker when the speaker articulates abnormally. Furthermore, the articulation abnormality detection device can accurately detect an articulation abnormality with a simple configuration by calculating a first speaker feature using a trained deep neural network (DNN) for distinguishing a speaker characteristic and determining an articulation abnormality based on a degree of similarity between the first speaker feature and a second speaker feature that is obtained when the speaker articulated properly.

A non-transitory computer-readable recording medium according to one aspect of the present disclosure is a non-transitory computer-readable recording medium for use in a computer, where the non-transitory computer-readable recording medium having recorded thereon a computer program for causing the computer to execute the above-described articulation abnormality detection method.

Note that these general and specific aspects may be implemented using a system, a method, an integrated circuit, a computer program, or a computer-readable recording medium such as a CD-ROM, or any combination of systems, methods, integrated circuits, computer programs, or computer-readable recording media.

Hereinafter, embodiments will be described in detail with reference to the drawings. Note that the embodiments described below each show a specific example of the present disclosure. Therefore, the numerical values, shapes, materials, elements, the arrangement and connection of the elements, steps, orders of the steps, etc. presented in the embodiments below are mere examples and are not intended to limit the present disclosure. Furthermore, among the elements in the embodiments below, those not recited in any one of the independent claims will be described as optional elements.

### Embodiment 1

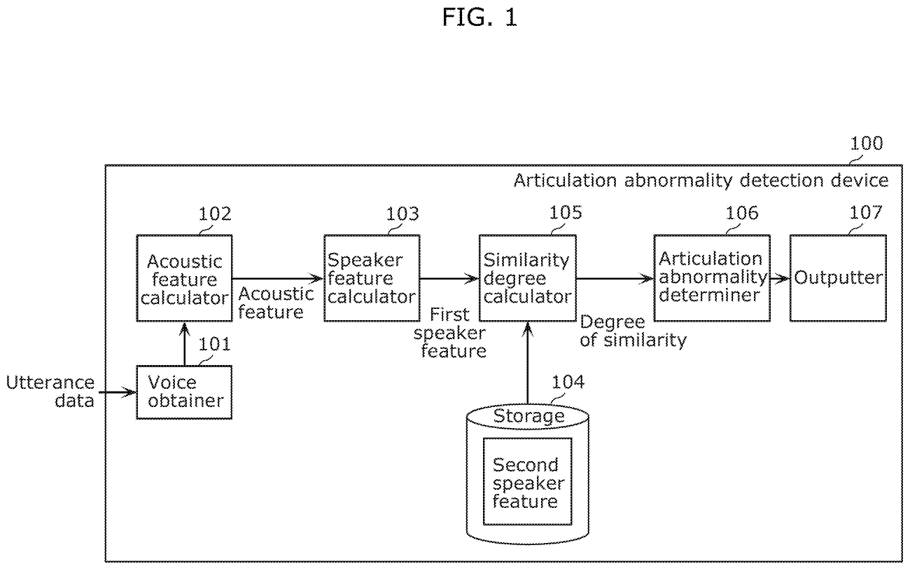

FIG. 1 is a block diagram illustrating articulation abnormality detection device 100 according to an embodiment. Articulation abnormality detection device 100 detects an articulation abnormality of a speaker (user). In other words, articulation abnormality detection device 100 determines whether the speaker has an articulation abnormality (or a possibility of the speaker having an articulation abnormality). For example, articulation abnormality detection device 100 is included in a terminal device such as a smartphone or a tablet terminal. Note that functions of articulation abnormality detection device 100 may be implemented by a single device or a plurality of devices. For example, some of functions of articulation abnormality detection device 100 may be implemented by a terminal device, and the remaining functions may be implemented by a server or the like that is communicable with the terminal device.

As illustrated in FIG. 1, articulation abnormality detection device 100 includes voice obtainer 101, acoustic feature calculator 102, speaker feature calculator 103, storage 104, similarity degree calculator 105, articulation abnormality determiner 106, and outputter 107.

Voice obtainer 101 obtains utterance data that is voice data on an utterance given by a speaker. For example, voice obtainer 101 is a microphone, and generates utterance data by converting an obtained voice into an audio signal. Note that voice obtainer 101 may obtain utterance data generated outside articulation abnormality detection device 100.

Acoustic feature calculator 102 calculates, from utterance data, an acoustic feature concerning a voice of an utterance. For example, as an acoustic feature, acoustic feature calculator 102 calculates, from the utterance data, a mel-frequency cepstral coefficient (MFCC) that is a feature of the voice of the utterance. An MFCC is a feature indicating a property of the vocal tract of a speaker, and is also typically used in voice recognition. More specifically, an MFCC is an acoustic feature obtained by analyzing the frequency spectrum of a voice based on a property of the human sense of hearing. Note that acoustic feature calculator 102 may calculate, as an acoustic feature from utterance data, a result obtained by multiplying an audio signal of the utterance by a mel filter bank as an acoustic feature, or may calculate a spectrogram of the audio signal of the utterance as an acoustic feature.

Speaker feature calculator 103 extracts, from an acoustic feature calculated from utterance data, a first speaker feature for identifying a speaker of an utterance indicated by the utterance data. In other words, the first speaker feature indicates a speaker characteristic of the utterance data. More specifically, speaker feature calculator 103 uses a trained DNN to extract the first speaker feature from the acoustic feature.

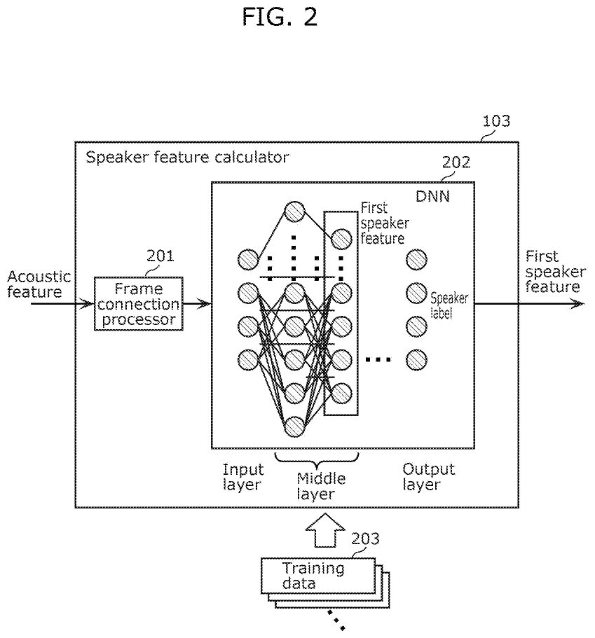

For example, speaker feature calculator 103 uses an x-vector method to extract the first speaker feature. Here, the x-vector method is a method for calculating a speaker feature that is a speaker-specific feature called an x-vector. FIG. 2 is a block diagram illustrating an example of a configuration of speaker feature calculator 103. As illustrated in FIG. 2, speaker feature calculator 103 includes frame connection processor 201 and DNN 202.

Frame connection processor 201 connects a plurality of acoustic features, and outputs the obtained acoustic feature to DNN 202. For example, frame connection processor 201 connects a plurality of frames of MFCCs each of which is an acoustic feature, and outputs the connected frames of MFCCs to an input layer of DNN 202. For example, frame connection processor 201 connects 50 frames of MFCC parameters, where each frame is composed of a 24-dimensional feature, to generate a 1200-dimensional vector. Frame connection processor 201 then outputs the generated vector to the input layer of DNN 202.

DNN 202 is a trained machine learning model that outputs a first speaker feature in accordance with an input acoustic feature. In the example shown in FIG. 2, DNN 202 is a neural network composed of an input layer, a plurality of middle layers, and an output layer. In addition, DNN 202 is generated in advance through machine learning using items of training data 203. Each item of training data 203 is data associating information identifying a speaker with utterance data of the speaker. In short, DNN 202 is a trained model that receives utterance data as an input, and outputs information (speaker label) identifying a speaker of the utterance data. However, DNN 202 in this embodiment outputs a first speaker feature that is generated as intermediate data.

Specifically, the output layer includes nodes each of which outputs a speaker label for the number of speakers contained in respective items of training data 203. The plurality of middle layers is composed of, for example, two to three middle layers, and includes a middle layer that calculates a first speaker feature. The middle layer that calculates a first speaker feature outputs, as an output of DNN 202, a calculated first speaker feature.

Storage 104 includes a rewritable, nonvolatile memory, such as a hard disk drive or a solid-state drive. Storage 104 stores a second speaker feature that is a first speaker feature of a speaker obtained when the speaker articulated properly.

Similarity degree calculator 105 calculates a degree of similarity between a first speaker feature output from speaker feature calculator 103 and a second speaker feature stored in storage 104. For example, similarity degree calculator 105 calculates a cosine using an inner product in a vector space model to calculate a cosine distance (also called a cosine similarity) indicating an angle between the vector of a first speaker feature and the vector of a second speaker feature as a degree of similarity. In this case, a larger value of an angle between the vectors indicates a lower degree of similarity. Note that, as a degree of similarity, similarity degree calculator 105 may calculate a cosine distance that takes values from −1 to 1, using an inner product of a vector indicating a first speaker feature and a vector indicating a second speaker feature. In this case, a larger value indicating a cosine distance indicates a higher degree of similarity.

Articulation abnormality determiner 106 determines whether a speaker has an articulation abnormality, based on a degree of similarity calculated by similarity degree calculator 105. For example, articulation abnormality determiner 106 determines that the speaker has an articulation abnormality when the degree of similarity is lower than a predetermined threshold. Note that articulation abnormality determiner 106 need not determine whether a speaker has an articulation abnormality, but may determine a possibility of the speaker having an articulation abnormality. For example, articulation abnormality determiner 106 may determine that a possibility of a speaker having an articulation abnormality is higher for a lower degree of similarity. Note that a result of such determination may be a classification of several stages, such as “there is a possibility,” “the possibility is high,” and “the possibility is very high,” or may be a value, etc. indicating the possibility.

Outputter 107 notifies, to a speaker, a determination result obtained by articulation abnormality determiner 106. For example, outputter 107 is a display or a loudspeaker included in a terminal device, and notifies the determination result to a speaker through a display or a voice. Note that outputter 107 may output the determination result to an external device.

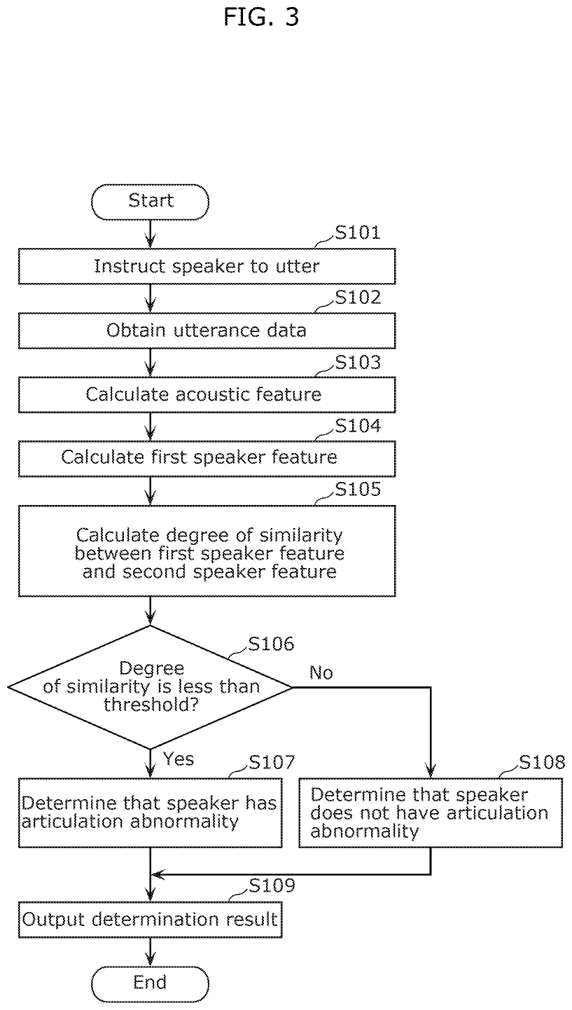

Hereinafter, an articulation abnormality detection process performed by articulation abnormality detection device 100 will be described. FIG. 3 is a flowchart illustrating the articulation abnormality detection process performed by articulation abnormality detection device 100. Note that the following describes the case where one speaker is registered in advance in articulation abnormality detection device 100.

First, articulation abnormality detection device 100 instructs a speaker (user) to utter a predetermined phrase (S101). For example, this instruction is given through a display or a voice.

Next, voice obtainer 101 obtains utterance data of the above phrase uttered by the speaker according to the instruction (S102). Next, acoustic feature calculator 102 calculates an acoustic feature from the utterance data (S103). Next, speaker feature calculator 103 calculates a first speaker feature from the acoustic feature (S104). Specifically, speaker feature calculator 103 outputs a first speaker feature corresponding to the input acoustic feature.

Next, similarity degree calculator 105 calculates a degree of similarity between the first speaker feature output from speaker feature calculator 103 and a second speaker feature stored in storage 104 (S105). For example, a second speaker feature is a first speaker feature that has been determined to be a first speaker feature not obtained when the speaker articulated abnormally in an articulation abnormality detection process performed in the past. Note that a second speaker feature may be calculated from a plurality of first speaker features obtained through a plurality of articulation abnormality detection processes performed in the past. For example, a second speaker feature may be the average value or the median value of a plurality of first speaker features obtained through a plurality of articulation abnormality detection processes performed in the past.

Articulation abnormality determiner 106 determines whether the speaker has an articulation abnormality, based on the degree of similarity calculated by similarity degree calculator 105. Specifically, articulation abnormality determiner 106 compares the degree of similarity with a predetermined threshold (S106). When the degree of similarity is less than the predetermined threshold (Yes in S106), articulation abnormality determiner 106 determines that the speaker has an articulation abnormality (S107). When the degree of similarity is greater than or equal to the predetermined threshold (No in S106), articulation abnormality determiner 106 determines that the speaker does not have an articulation abnormality (i.e., the speaker has proper articulation) (S108). Note that articulation abnormality determiner 106 need not determine whether the speaker has an articulation abnormality, but may determine a possibility of the speaker having an articulation abnormality. For example, articulation abnormality determiner 106 may determine that a possibility of the speaker having an articulation abnormality is higher for a lower degree of similarity.

Next, outputter 107 outputs a determination result obtained by articulation abnormality determiner 106 (S109). For example, outputter 107 notifies, to the speaker, the determination result obtained by articulation abnormality determiner 106.

Note that although the above description has shown an example in which one speaker is registered in advance, a plurality of speakers may be registered. In this case, a second speaker feature for each speaker is stored in storage 104. In addition, information identifying a speaker is input to articulation abnormality detection device 100, and the above-described process is performed using a second speaker feature of the identified speaker.

As has been described above, articulation abnormality detection device 100 calculates an acoustic feature from utterance data of a speaker. Articulation abnormality detection device 100 calculates, from the acoustic feature, a first speaker feature indicating a speaker characteristic of the utterance data by using a trained deep neural network (DNN). Articulation abnormality detection device 100 calculates a degree of similarity between a second speaker feature of the speaker and the first speaker feature, where the second speaker feature is a speaker feature obtained when the speaker articulated properly. Articulation abnormality detection device 100 determines whether the speaker has an articulation abnormality, based on the degree of similarity. For example, articulation abnormality detection device 100 determines that the speaker has an articulation abnormality when the degree of similarity is less than a predetermined first threshold.

In other words, articulation abnormality detection device 100 uses a first speaker feature obtained by a trained DNN that calculates the first speaker feature indicating a speaker characteristic from utterance data to detect an articulation abnormality of a speaker by taking advantage of an occurrence of a change in the first speaker feature when the speaker is articulating abnormally compared to when the speaker is articulating properly. As described above, since the DNN that has been already generated for distinguishing speakers is used, it is not necessary to generate a new DNN for determining whether a speaker has an articulation abnormality. Accordingly, since articulation abnormality detection device 100 does not require training data that is to be obtained when a speaker articulates abnormally as described above, articulation abnormality detection device 100 can implement a detection process not being dependent on the amount of training data that is to be obtained when a speaker articulates abnormally.

### Embodiment 2

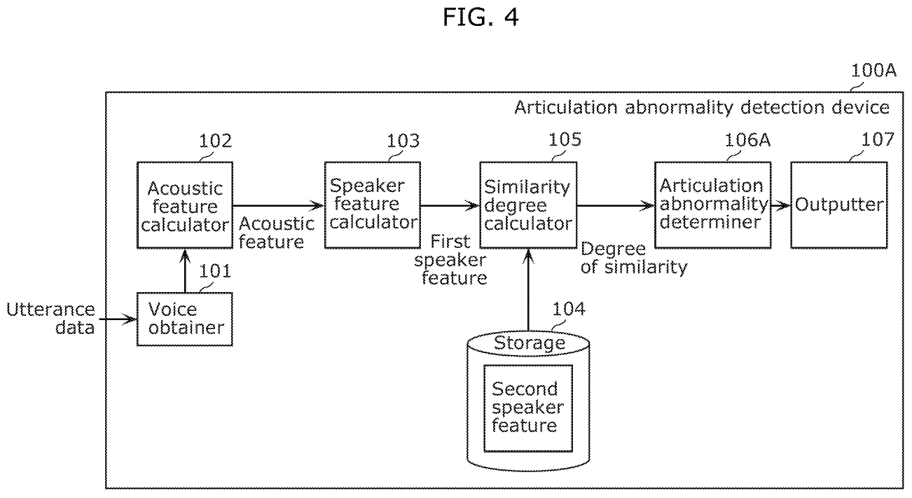

FIG. 4 is a block diagram illustrating articulation abnormality detection device 100A according to an embodiment. In articulation abnormality detection device 100A shown in FIG. 4, a function of articulation abnormality determiner 106A is mainly different from articulation abnormality determiner 106 shown in FIG. 1.

Articulation abnormality detection device 100A calculates a degree of similarity for each of items of utterance data corresponding to utterances. Articulation abnormality determiner 106A calculates a variance of the calculated degrees of similarity, and determines whether a speaker has an articulation abnormality based on the calculated variance.

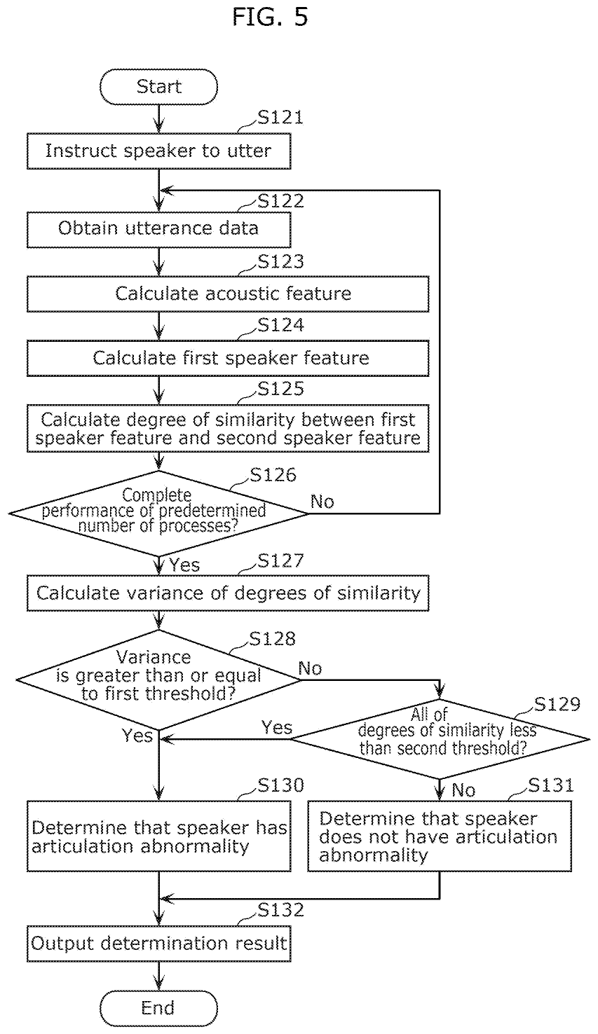

FIG. 5 is a flowchart illustrating an articulation abnormality detection process performed by articulation abnormality detection device 100A. Note that the following describes the case where one speaker is registered in advance in articulation abnormality detection device 100A.

First, articulation abnormality detection device 100A instructs a speaker (user) to utter the same predetermined phrase for several times (S121). For example, this instruction is given through a display or a voice.

Next, voice obtainer 101 obtains utterance data of the above phrase uttered by the speaker according to the instruction (S122). Next, acoustic feature calculator 102 calculates an acoustic feature from the utterance data (S123). Next, speaker feature calculator 103 calculates a first speaker feature from the acoustic feature (S124). Next, similarity degree calculator 105 calculates a degree of similarity between the first speaker feature output from speaker feature calculator 103 and a second speaker feature stored in storage 104 (S125). In addition, a process of from step S122 to step S125 will be repeatedly performed until the process for each utterance completes (S126), and degrees of similarity corresponding to the utterances are calculated.

Next, articulation abnormality determiner 106A calculates a variance of the calculated degrees of similarity (S127), and determines whether the calculated variance is greater than or equal to a predetermined first threshold (S128). When the variance is greater than or equal to the first threshold (Yes in S128), articulation abnormality determiner 106A determines that the speaker has an articulation abnormality (S130).

Alternatively, when the variance is less than the first threshold (No in S128), articulation abnormality determiner 106A determines whether all of the degrees of similarity are less than a second threshold (S129). When all of the degrees of similarity are less than the second threshold (Yes in S129), articulation abnormality determiner 106A determines that the speaker has an articulation abnormality (S130). In addition, when at least one of the degrees of similarity is greater than or equal to the second threshold (No in S129), articulation abnormality determiner 106A determines that the speaker does not have an articulation abnormality (i.e., the speaker has proper articulation) (S131). Note that articulation abnormality determiner 106A may determine, in step S129, whether at least one of the degrees of similarity is less than the second threshold. In other words, when at least one of the degrees of similarity is less than the second threshold, articulation abnormality determiner 106A may determine that the speaker has an articulation abnormality (S130), and when all of the degrees of similarity are greater than or equal to the second threshold, articulation abnormality determiner 106A may determine that the speaker does not have an articulation abnormality (S131). Alternatively, articulation abnormality determiner 106A may determine, in step S129, whether a first evaluation value calculated from the degrees of similarity is less than the second threshold. In other words, when the first evaluation value is less than the second threshold, articulation abnormality determiner 106A may determine that the speaker has an articulation abnormality (S130), and when the first evaluation value is greater than or equal to the second threshold, articulation abnormality determiner 106A may determine that the speaker does not have an articulation abnormality (S131). This first evaluation value is, for example, the average value, the median value, the maximum value, or the minimum value of the degrees of similarity.

Moreover, the order of step S128 and step S129 may be reversed. In other words, articulation abnormality determiner 106A may determine that (i) the speaker has an articulation abnormality when at least one of a first condition that the variance is greater than or equal to the first threshold and a second condition that all of the degrees of similarity are less than the second threshold is satisfied, and (ii) the speaker does not have an articulation abnormality when both of the first condition and the second condition are not satisfied. Note that articulation abnormality determiner 106A may determine that the speaker has an articulation abnormality when both of the first condition and the second condition are satisfied, and articulation abnormality determiner 106A may determine that the speaker does not have an articulation abnormality when at least one of the first condition and the second condition is not satisfied.

Note that articulation abnormality determiner 106A need not determine whether a speaker has an articulation abnormality, but may determine a possibility of the speaker having an articulation abnormality. For example, articulation abnormality determiner 106A may calculate a second evaluation value based on a variance and a first evaluation value, and may determine a possibility of a speaker having an articulation abnormality based on the second evaluation value. For example, articulation abnormality determiner 106A calculates a second evaluation value by weighted addition of the inverse of the variance and the first evaluation value. In addition, articulation abnormality determiner 106A determines that a possibility of the speaker having an articulation abnormality is higher for a lower second evaluation value. In other words, articulation abnormality determiner 106A determines that the possibility of the speaker having an articulation abnormality is higher for a higher variance, and determines that the possibility of the speaker having an articulation abnormality is higher for a lower first evaluation value.

Next, outputter 107 outputs a determination result obtained by articulation abnormality determiner 106A (S132). For example, outputter 107 notifies, to the speaker, the determination result obtained by articulation abnormality determiner 106A.

As has been described above, articulation abnormality detection device 100A calculates a plurality of acoustic features from respective items of utterance data of a speaker, calculates a plurality of first speaker features from the plurality of acoustic features by using a trained DNN, and calculates a plurality of degrees of similarity between the second speaker feature and the plurality of first speaker features. Articulation abnormality detection device 100A calculates a variance of the plurality of degrees of similarity, and determines that the speaker has an articulation abnormality when the variance is greater than a predetermined second threshold.

According to the above, articulation abnormality detection device 100A can accurately detect an articulation abnormality by taking advantage of a predisposition to difficulty in repeating the same phrase when a speaker is articulating abnormally.

### Embodiment 3

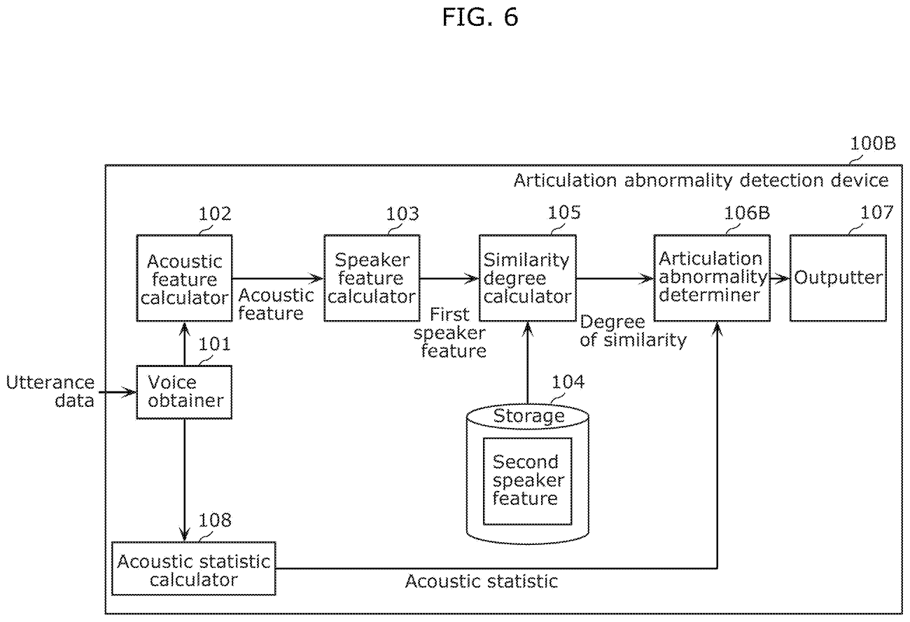

FIG. 6 is a block diagram illustrating articulation abnormality detection device 100B according to an embodiment. Articulation abnormality detection device 100B shown in FIG. 6 includes acoustic statistic calculator 108, in addition to elements included in articulation abnormality detection device 100 shown in FIG. 1. Moreover, articulation abnormality determiner 106B has a function different from the function of articulation abnormality determiner 106.

Acoustic statistic calculator 108 calculates an acoustic statistic from utterance data. For example, an acoustic statistic includes at least one of a pitch variation (intonation), waveform periodicity, and skewness. Articulation abnormality determiner 106B determines whether a speaker has an articulation abnormality based on a degree of similarity and an acoustic statistic.

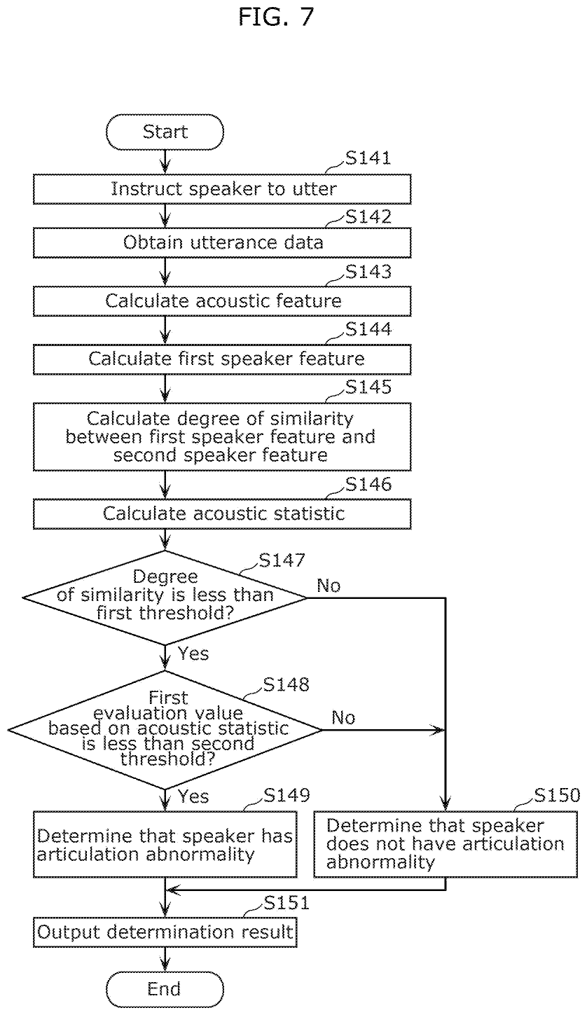

FIG. 7 is a flowchart illustrating an articulation abnormality detection process performed by articulation abnormality detection device 100B. Note that the following describes the case where one speaker is registered in advance in articulation abnormality detection device 100B.

First, articulation abnormality detection device 100B instructs a speaker (user) to utter a predetermined phrase (S141). For example, this instruction is given through a display or a voice.

Next, voice obtainer 101 obtains utterance data of the above phrase uttered by the speaker according to the instruction (S142). Next, acoustic feature calculator 102 calculates an acoustic feature from the utterance data (S143). Next speaker feature calculator 103 calculates a first speaker feature from the acoustic feature (S144). Next, similarity degree calculator 105 calculates a degree of similarity between the first speaker feature output from speaker feature calculator 103 and a second speaker feature stored in storage 104 (S145).

In addition, acoustic statistic calculator 108 calculates an acoustic statistic from the utterance data (S146). Next, articulation abnormality determiner 106B determines whether the speaker has an articulation abnormality, based on the degree of similarity and the acoustic statistic.

Specifically, articulation abnormality determiner 106B determines whether the degree of similarity is less than a predetermined first threshold (S147). When the degree of similarity is less than the first threshold (Yes in S147), articulation abnormality determiner 106B determines whether a first evaluation value based on the acoustic statistic is less than a predetermined second threshold (S148). When the first evaluation value is less than the second threshold (Yes in S148), articulation abnormality determiner 106B determines that the speaker has an articulation abnormality (S149). Moreover, when the degree of similarity is greater than or equal to the first threshold (No in S147), or when the first evaluation value is greater than or equal to the second threshold (No in S148), articulation abnormality determiner 106B determines that the speaker does not have an articulation abnormality (i.e., the speaker has proper articulation) (S150).

For example, the first evaluation value is higher for (i) greater pitch variations and (ii) longer waveform periodicity, and the first evaluation value is lower for greater skewness. For example, articulation abnormality determiner 106B calculates a first evaluation value by weighted addition of a pitch variation, waveform periodicity, and the inverse of skewness.

In other words, articulation abnormality determiner 106B determines that a possibility of the speaker having an articulation abnormality is higher for smaller pitch variations. In addition, articulation abnormality determiner 106B determines that a possibility of the speaker having an articulation abnormality is higher for shorter waveform periodicity. Note that short waveform periodicity means that there is a lot of noise. Moreover, articulation abnormality determiner 106B determines that a possibility of the speaker having an articulation abnormality is higher for a greater skewness.

In addition, the order of step S147 and step S148 may be reversed. In other words, when both of a first condition that the degree of similarity is less than the first threshold and a second condition that the first evaluation value based on an acoustic statistic is less than the second threshold are satisfied, articulation abnormality determiner 106B may determine that the speaker has an articulation abnormality, and when at least one of the first condition and the second condition is not satisfied, articulation abnormality determiner 106B may determine that the speaker does not have an articulation abnormality (i.e., the speaker has proper articulation).

Note that when at least one of the first condition and the second condition is satisfied, articulation abnormality determiner 106B may determine that the speaker has an articulation abnormality, and when both of the first condition and the second condition are not satisfied, articulation abnormality determiner 106B may determine that the speaker does not have an articulation abnormality (i.e., the speaker has proper articulation). Alternatively, articulation abnormality determiner 106B may calculate a second evaluation value from the degree of similarity and the first evaluation value, and may determine that (i) the speaker has an articulation abnormality when the second evaluation value is less than a third threshold and (ii) the speaker does not have an articulation abnormality when the second evaluation value is greater than or equal to the third threshold. For example, articulation abnormality determiner 106B calculates the second evaluation value by weighted addition of the degree of similarity and the first evaluation value. Moreover, articulation abnormality determiner 106B may determine that a possibility of the speaker having an articulation abnormality is higher for a lower second evaluation value.

Note that articulation abnormality determiner 106B need not calculate the first evaluation value, but may compare each of a pitch variation, waveform periodicity, and skewness with a corresponding threshold. For example, articulation abnormality determiner 106B may determine that a speaker has an articulation abnormality when at least one of the following conditions is satisfied: (i) a condition that a pitch variation is less than a fourth threshold, (ii) a condition that waveform periodicity is less than a fifth threshold, and (iii) a condition that skewness is greater than or equal to a sixth threshold. When none of these conditions is satisfied, articulation abnormality determiner 106B may determine that the speaker does not have an articulation abnormality.

Next, outputter 107 outputs a determination result obtained by articulation abnormality determiner 106B (S151). For example, outputter 107 notifies, to the speaker, the determination result obtained by articulation abnormality determiner 106B.

Note that this embodiment has presented an example in which an acoustic statistic is additionally used for the configuration described in Embodiment 1; however, an acoustic statistic may be additionally used for the configuration described in Embodiment 2.

As has been described above, articulation abnormality detection device 100B calculates an acoustic statistic from utterance data, and determines whether a speaker has an articulation abnormality, based on a degree of similarity and the acoustic statistic. According to the above, articulation abnormality detection device 100B can accurately detect an articulation abnormality by making a determination with consideration given to an acoustic statistic, in addition to the degree of similarity between a first speaker feature and a second speaker feature that is obtained when the speaker articulated properly.

Hereinbefore, an articulation abnormality detection device according to embodiments of the present disclosure has been described, but the present disclosure is not limited to these embodiments.

In addition, each of processors included in the articulation abnormality detection device according to the above embodiments are typically implemented as an LSI circuit that is an integrated circuit. These processors may be individually implemented as a single chip, or some or all of the processors may be implemented as a single chip.

Moreover, circuit integration is not limited to an LSI circuit; circuit integration may be implemented as a dedicated circuit or a generic processor. A field programmable gate array (FPGA) that is programmable after manufacturing of the LSI circuit, or a reconfigurable processor whose circuit cell connections and settings in the LSI circuit are reconfigurable, may be used.

In addition, in the above embodiments, elements may be configured as dedicated hardware or may be implemented by executing a software program suitable for the element. Each element may be implemented as a result of a program execution unit, such as a central processing unit (CPU), processor or the like, loading and executing a software program stored in a storage medium such as a hard disk or a semiconductor memory.

Furthermore, the present disclosure may be implemented as an articulation abnormality detection method or the like that is implemented by an articulation abnormality detection device or the like.

The block diagrams each illustrate one example of the division of functional blocks, but a plurality of functional blocks may be implemented as a single functional block, a single functional block may be broken up into a plurality of functional blocks, and part of one function may be transferred to another functional block. Moreover, the functions of a plurality of function blocks having similar functions may be processed by a single piece of hardware or software in parallel or by time-division.

The order of steps in each flowchart is presented to exemplify the present disclosure in detail; the order of the steps may be other than the order presented above. Moreover, some of the steps may be executed at the same time as (or in parallel with) other steps.

Hereinbefore, an articulation abnormality detection device, etc. according to one or more aspects has been described based on the embodiments, but the present disclosure is not limited to these embodiments. The scope of the one or more aspects of the present disclosure may encompass embodiments as a result of making, to the embodiments, various modifications that may be conceived by those skilled in the art and combining elements in different embodiments, as long as the resultant embodiments do not depart from the scope of the present disclosure.

### INDUSTRIAL APPLICABILITY

The present disclosure is applicable to articulation abnormality detection devices.

1. An articulation abnormality detection method comprising:
calculating an acoustic feature from utterance data of a speaker;
calculating, from the acoustic feature, a first speaker feature indicating a speaker characteristic of the utterance data by using a trained deep neural network (DNN);
calculating a degree of similarity between a second speaker feature of the speaker and the first speaker feature, the second speaker feature being a speaker feature obtained when the speaker articulated properly; and
determining whether the speaker has an articulation abnormality, based on the degree of similarity.

2. The articulation abnormality detection method according to claim 1, wherein
in the determining, the speaker is determined to have an articulation abnormality when the degree of similarity is less than a predetermined first threshold.

3. The articulation abnormality detection method according to claim 1, wherein
in the calculating of the acoustic feature, acoustic features including the acoustic feature are calculated from respective items of utterance data of the speaker including the utterance data,
in the calculating of the first speaker feature, first speaker features including the first speaker feature are calculated from the acoustic features by using the trained DNN,
in the calculating of the degree of similarity, degrees of similarity between the second speaker feature and the first speaker features are calculated, the degrees of similarity including the degree of similarity, and
in the determining:
a variance of the degrees of similarity is calculated; and
when the variance is greater than a predetermined second threshold, the speaker is determined to have an articulation abnormality.

4. The articulation abnormality detection method according to claim 1, further comprising:
calculating an acoustic statistic from the utterance data, wherein
the determining includes determining whether the speaker has an articulation abnormality, based on the degree of similarity and the acoustic statistic.

5. The articulation abnormality detection method according to claim 4, wherein
the acoustic statistic includes a pitch variation, and
in the determining, a possibility of the speaker having an articulation abnormality is determined to be higher for smaller pitch variations.

6. The articulation abnormality detection method according to claim 4, wherein
the acoustic statistic includes waveform periodicity, and
in the determining, a possibility of the speaker having an articulation abnormality is determined to be higher for shorter waveform periodicity.

7. The articulation abnormality detection method according to claim 4, wherein
the acoustic statistic includes skewness, and
in the determining, a possibility of the speaker having an articulation abnormality is determined to be higher for greater skewness.

8. An articulation abnormality detection device comprising:
an acoustic feature calculator that calculates an acoustic feature from utterance data of a speaker;
a speaker feature calculator that calculates, from the acoustic feature, a first speaker feature indicating a speaker characteristic of the utterance data by using a trained deep neural network (DNN);
a similarity degree calculator that calculates a degree of similarity between a second speaker feature of the speaker and the first speaker feature, the second speaker feature being a speaker feature obtained when the speaker articulated properly; and
an articulation abnormality determiner that determines whether the speaker has an articulation abnormality, based on the degree of similarity.

9. A non-transitory computer-readable recording medium for use in a computer, the recording medium having recorded thereon a computer program for causing the computer to execute the articulation abnormality detection method according to claim 1.
